(19) United States
(12) Patent Application Publication
(10) Pub. No.: US 2025/0370911 A1
(43) Pub. Date: Dec. 4, 2025

(54) SYSTEM-ON-CHIP INCLUDING A PROCESSOR HAVING DEBUGGING FUNCTIONALITY AND A TAMPER CIRCUIT, AND CORRESPONDING TAMPER PROTECTION METHOD

(71) Applicant: STMicroelectronics International N.V., Geneva (CH)

(72) Inventor: Jawad BENHAMMADI, Pont de Claix (FR)

(73) Assignee: STMicroelectronics International N.V., Geneva (CH)

(21) Appl. No.: 19/211,782

(22) Filed: May 19, 2025

(30) Foreign Application Priority Data
May 29, 2024 (FR) FR2405529

(51) Int. Cl. G06F 11/362

(52) U.S. Cl. CPC G06F 11/362

(57) ABSTRACT

A system-on-chip includes a processor having program debugging functionality. Debug parameters are determined by debug command signals. A tamper circuit detect states on said debug command signals which represent debug access permission.

### PRIORITY CLAIM

This application claims the priority benefit of French Application for Patent No. FR2405529, filed on May 29, 2024, the content of which is hereby incorporated by reference in its entirety to the maximum extent allowable by law.

### TECHNICAL FIELD

Embodiments relate to systems on a chip (SOC), i.e., integrated circuits incorporating a complete system such as microcontrollers, and more specifically methods and means to protect against reverse engineering attacks.

### BACKGROUND

In reverse engineering processes, attacks are deemed actions that aim, for example, to access sensitive or confidential information, such as encryption data or program code.

In this regard, there are techniques for directing attacks on the debugging functionality of a central processing unit (CPU).

Indeed, if access to the debugging functionality is allowed, then it is possible to read an address via a debug command, typically via a dedicated Debug Access Port (DAP).

The “DAP” access port interface is conventionally able to filter debug requests, by fully closing off access to the processor.

For example, the owner of the system-on-chip, normally called the original equipment manufacturer (OEM), has a “fully open” initial state of the system, where access to the debugging functionality is fully permitted.

As software development progresses, access to the debugging functionality will be gradually restricted until there is a fully closed state.

In particular, the succession of states could comprise: the “fully open” state where the application has not yet been developed; then a “provisioning” state enabling secrets (keys, secrets, etc.) to be written to the system; then a “provisioned” state when the provisioning phase has just been completed; then, for example, a “closed trust zone” when the development of the “secure” application has been completed; then the “fully closed” state when the development of the final application has been completed.

Typically, between the “closed trust zone” state and the “fully closed” state, for example, another client may be responsible for coding the non-secure application, for example the rich operating system, and has to have processor debugging functionalities.

And, in this context, there is a vulnerability, for example through a hardware attack such as fault injection using laser pulses, on debug isolation command signals.

The debug isolation command signals enable or prevent access to information having secure access rights during debugging, for example. In addition, debug isolation command signals can also determine, for example, whether invasive debugging (allowing variables to be read, breakpoints to be entered, etc.) or non-invasive debugging (communicating only an execution trace) is permitted.

In fact, in the “closed trusted zone” state, for example, access to secure zones should be impossible, but by manipulation with a hardware attack on, for example, the debug isolation command signal enabling invasive secure level access, confidential information can be obtained via the debugging functionality.

There is therefore a need to guard against this vulnerability.

### SUMMARY

In this regard, according to one aspect, a system-on-chip is proposed including a processor having program debugging functionality, designed to have debug parameters determined by debug command signals, wherein a tamper circuit is designed to detect states representing debug access permission on said debug command signals.

Therefore, if at least one of the debug command signals is altered (e.g., manipulated by a hardware attack) into a state commanding access permission (potentially any permission for any access), then this is detected by the tamper circuit, although the system theoretically allows this state of the debug command signal. The tamper circuit thus enables the system “to know” that access permission is commanded by said signal, thus enabling a decision to be taken as to the legitimacy of this command. If it is illegitimate, measures could be taken to protect the system.

According to one embodiment in this regard, a countermeasure is designed to activate system protection measures in the event of detection performed by the tamper circuit and as a function of a system access right state.

For example, the countermeasure is implemented via software in a secure environment with information about the system access right state, for example within a management function provided for managing the system access rights on a chip. For example, protection measures can comprise switching off the system-on-chip, deleting sensitive data, or even the self-destruction of the system.

According to one embodiment, the tamper circuit is designed to detect a state representing debug access permission at a secure level and/or debug access permission at a non-secure level, on at least one debug command signal configuring the respective access rights.

According to one embodiment, the tamper circuit is designed to detect a state representing invasive debug access permission and/or non-invasive debug access permission, on at least one debug command signal configuring the respective degree of invasiveness.

According to one embodiment, where the processor is designed to provide evolving system state information, the tamper circuit is designed to perform said detection on the debug command signals in all system states except an initial “fully open” state.

According to another aspect, a system-on-chip tamper protection method is proposed comprising a processor having program debugging functionality, debug command signals determining processor debug parameters, the tamper protection method comprising detecting states representing debug access permission on said debug command signals.

According to one embodiment, the method comprises detecting a state representing debug access permission at a secure level and/or debug access permission at a non-secure level, on at least one debug command signal configuring the respective access rights.

According to one embodiment, the method comprises detecting a state representing invasive debug access permission and/or non-invasive debug access permission, on at least one debug command signal configuring the respective degree of invasiveness.

According to one embodiment, said detection on the debug command signals is performed in all system states except an initial “fully open” state, the evolving system state information being provided by the processor.

According to one embodiment, system protection measures are activated in the event of detection of at least one state representing debug access permission, and as a function of a system access right state.

### BRIEF DESCRIPTION OF THE DRAWINGS

Other advantages and features of the invention will become apparent upon examining the detailed description of non-limiting embodiments and implementations, and from the accompanying drawings, where in the figures:

FIG. 1 shows an exemplary system-on-chip (SOC); and

FIG. 2 shows a functional illustration of a tamper protection method performed by the SOC of FIG. 1.

### DETAILED DESCRIPTION

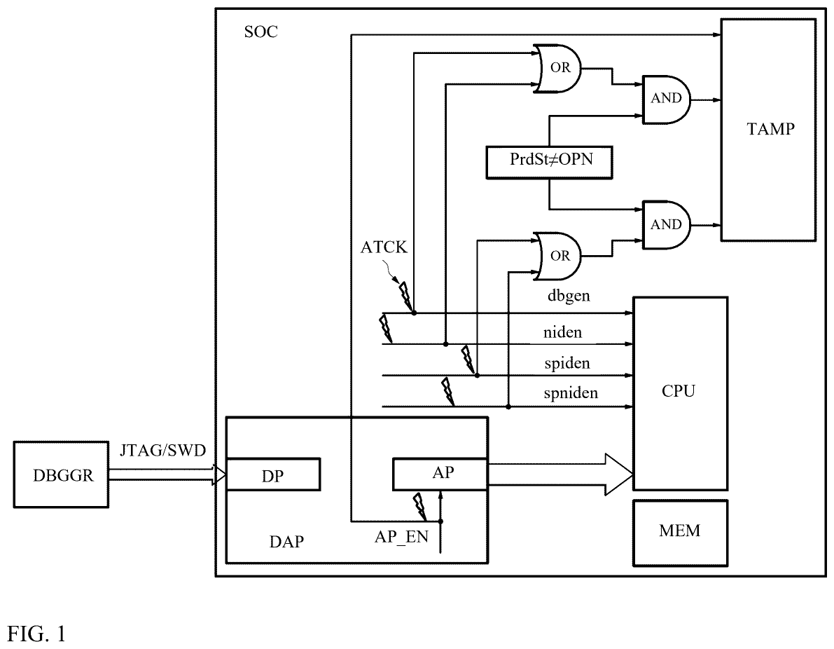

FIG. 1 shows an exemplary system-on-chip SOC including a central processing unit (CPU), normally referred to as a processor, able to execute software code, and in particular according to a debugging functionality.

In this regard, the system has a debug access port DAP as well as a memory MEM, which can, for example, contain the program code executed by the processor, and a tamper circuit TAMP.

A third-party system referred to as a debugging system DBGGR can access the processor CPU to initiate debugging via the debug access port DAP. The third-party debugging system DBGGR can, for example, be a desktop computer on which a software code is designed by a programmer, and used to test the code implemented by the system-on-chip SOC.

The debug access port DAP has an input interface, or a debug port DP, for example following the JTAG or SWD protocol.

The abbreviation JTAG is short for “Joint Test Action Group” and refers to the IEEE 1149.1 standard known as “Standard Test Access Port and Boundary-Scan Architecture”.

The JTAG interface is used, in particular, for intra-circuit debugging, providing in particular direct access to the inside of the processor, such as breakpoints, reading and writing internal registers or internal and external memories.

The abbreviation SWD stands for “Serial Wire Debug” and refers to a debugging technique that is equivalent to JTAG and uses the same connector interface.

The debug access port DAP has an output interface, or an integrated circuit bus access port AP, accessing the processor CPU according to an integrated circuit bus, for example according to an Advanced High-performance Bus (AHB) protocol.

For example, a first isolation signal AP_EN is provided in the debug access port DAP to determine whether or not debug requests can be sent from the input interface DP to the output interface DA, and thus in particular by fully closing off access to the processor CPU.

Indeed, as software development progresses, access to the debugging functionality will be gradually restricted until there is a fully closed state where it is no longer possible to make use of the debugging functionality of the processor CPU.

Thus, on the one hand, in order to guard against a hardware attack able to alter the state of this first isolation signal so as to re-open access to the debugging functionality, monitoring of the state of the first isolation signal can be provided, by means of the tamper circuit TAMP.

A hardware attack able to alter the state of such a signal can, for example, be carried out with a pulsed laser fault injection technique. Other techniques able to alter the state of a signal may exist.

In this way, when the monitored signal is illegitimately set to a state granting access to the debugging functionality, the tamper circuit detects it, and the system can be designed to initiate defensive countermeasures conditional on this detection.

In addition, on the other hand, there are debug isolation command signals provided to allow or deny the processor CPU access to information having secure or non-secure access rights during debugging.

In other words, there is at least one debug command signal configuring the access rights, the state of which represents debug access permission at a secure level and/or debug access permission at a non-secure level.

In addition, there are debug isolation command signals provided to allow the processor CPU to provide so-called “invasive” debug access or so-called “non-invasive” debug access, or prevent it from doing so.

In other words, there is at least one debug command signal configuring the degree of invasiveness, the state of which represents invasive debug access permission and/or non-invasive debug access permission.

Invasive debugging enables variables to be read from and written to system registers and memories, breakpoints to be entered in the program, etc., while non-invasive debugging only enables communication of an execution trace of the program.

In practice, it is possible to provide the following four debug command signals to configure the access rights and degree of invasiveness of debugging:
1) the command signal dbgen, a first state of which, for example the “true” or “1” state, commands permission for invasive debugging of content with non-secure access rights;
2) the command signal niden, a first state of which, for example the “true” or “1” state, commands permission for non-invasive debugging of content with non-secure access rights;
3) the command signal spiden, a first state of which, for example the “true” or “1” state, commands permission for invasive debugging of content with secure access rights; and
4) the command signal spniden, a first state of which, for example the “true” or “1” state, commands permission for non-invasive debugging of content with non-secure access rights.

The tamper circuit is thus designed to detect states representing debug access permission, on said debug command signals determining the debug parameters implemented by the processor.

Therefore, if at least one of the debug command signals dbgen, niden, spiden, spnide is altered, i.e., for example manipulated by a hardware attack, and set to a state commanding access permission, then this is detected by the tamper circuit TAMP.

It can advantageously be provided that all access permissions, whatever the type of access (secure rights or degree of invasiveness) are detected by the tamper circuit TAMP.

It can also advantageously be provided to perform said detection in all states of the system, except in an initial “fully open” state, the processor being designed to provide evolving data representing the state of the system.

In the advantageous example shown in FIG. 1, the debug command signals configuring the “secure” access rights spiden, spniden have been grouped together, and the debug command signals configuring the “non-secure” access rights dbgen, niden have been grouped together so as to from two or three detection sources:

Detection of opening of non-secure debugging is based on the signals dbgen and niden: when non-secure debugging is open (dbgen=1 OR niden=1), an event is detected.

Detection of opening of secure debugging is based on the signals spiden and spniden: when secure debugging is open (spiden=1 OR spniden=1), an event is detected.

Optionally, detection of opening of the debug access port AP_EN. When the access port is open, an event is detected.

Furthermore, the detection of opening of both non-secure and secure debugging is cumulatively conditioned by the logical “AND” operation by the requirement that the system is not in the fully open state PrdSt≠OPN.

Logic gates offering the logical “OR” condition are designated by the reference OR, and the logic gate offering the logical “AND” condition is designated by the reference AND.

When an event is detected, it is possible to trigger an interruption and all the sensitive data in the system SOC (present in the memory MEM or in other circuits of the system SOC) is deleted.

Thus, the tamper circuit TAMP enables the system “to know” that access permission is commanded by said signal, enabling a decision to be taken as to the legitimacy of this command. Indeed, the system enables normal usage in which the debug command signals are used to grant respective access.

A trusted entity may be configured to make said decision relating to the legitimacy or lack thereof of the state of the debug command signal detected.

For example, the trusted entity can be implemented via software in a secure environment of the processor CPU, and for example in an environment with information about the system access right state, for example integrated into a means for managing access rights of the system-on-chip.

For example, the trusted entity is able to activate system protection measures, such as switching off the system-on-chip, deleting sensitive data, or even the self-destruction of the system as a consequence of a detection performed by the tamper circuit and in knowledge of a system access right state.

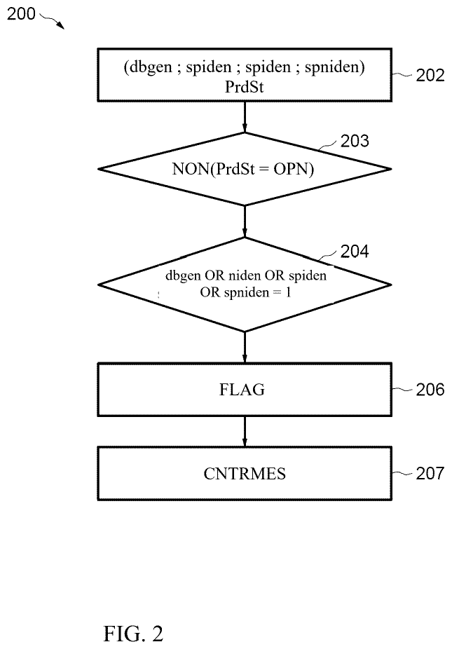

Reference is now made to FIG. 2.

FIG. 2 provides a functional illustration of a tamper protection method 200, for example carried out by the system-on-chip SOC described above in relation to FIG. 1.

In a step 202, debug command signals (dbgen; niden; spiden; spniden) have logic states, for example “0” or “1”, to determine debug parameters.

The logic states of the debug command signals (dbgen; niden; spiden; spniden) can be generated during normal operation of the system or by corrupting the system by means of a physical attack.

For example, the state “1” commands access permission (also referred to as “opening”) while the state “0” commands access restriction or prohibition (also referred to as “closing”).

A state of the system PrdSt is optionally communicated in step 202.

In an optional step 203, a logic test “NON (PrdSt=OPN)” is carried out to check that the system is not in the fully open state.

In a step 204, detection of states representing debug access permission is performed on said debug command signals (dbgen; niden; spiden; spniden), for example by a logic test “dbgen OR niden OR spiden OR spniden=1” verifying that at least one of said signals is set to state “1””.

Alternatively (see FIG. 1), the method 200 comprises in step 204 detecting a state representing debug access permission at a secure level and/or debug access permission at a non-secure level, on at least one debug command signal configuring the respective access rights.

To this end, it is possible to provide two parallel logic tests “dbgen OR niden=1”, verifying on the one hand that at least one of said signals commands an opening of non-secure debugging; and “spiden OR spniden=1” verifying on the other hand that at least one of said signals commands an opening of secure debugging.

In another alternative (not shown), the method 200 comprises in step 204 detecting a state representing invasive debug access permission and/or non-invasive debug access permission, on at least one debug command signal configuring the respective degree of invasiveness.

To this end, it is possible to provide two parallel logic tests “dbgen OR spiden=1”, verifying on the one hand that at least one of said signals commands an opening of intrusive debugging; and “niden OR spniden=1” verifying on the other hand that at least one of said signals commands an opening of non-intrusive debugging.

In a step 206, a piece of information FLAG is recorded, for example in a register, to communicate that detection of states representing debug access permission is performed on said debug command signals (dbgen; niden; spiden; spniden).

In an optional step 207, system protection measures CNTRMES are activated in the event of detection of at least one state representing debug access permission, and as a function of a system access right state.

The system access right state is typically known by a means for managing access rights, for example implemented via software by a trusted entity implemented in a secure environment of the processor CPU.

For example, system protection measures can comprise switching off the system-on-chip, deleting sensitive data, or the self-destruction of the system.

1. A system-on-chip, including:
a processor having a program debugging functionality, wherein said program debugging functionality is configured to have debug parameters determined by debug command signals; and
a tamper circuit configured to detect states of said debug command signals which represent debug access permission.

2. The system-on-chip according to claim 1, wherein the tamper circuit is configured to detect on at least one debug command signal a state representing debug access permission at a secure level and/or debug access permission at a non-secure level which configures respective access rights.

3. The system-on-chip according to claim 1, wherein the tamper circuit is configured to detect on at least one debug command signal a state representing invasive debug access permission and/or non-invasive debug access permission which configures a respective degree of invasiveness.

4. The system-on-chip according to claim 3, wherein the processor is configured to provide evolving system state information, wherein the tamper circuit operates to perform detection of states of said debug command signals in all system states except an initial “fully open” state.

5. The system-on-chip according to claim 1, further comprising a trusted entity configured to activate system protection measures in event of detection performed by the tamper circuit and as a function of a system access right state.

6. A system-on-chip tamper protection method, comprising:
executing through a processor a program debugging functionality;
wherein the program debugging functionality has processor debug parameters determined by debug command signals; and
detecting on said debug command signals detecting states representing debug access permission for tamper protection.

7. The method according to claim 6, comprising detecting a state representing debug access permission at a secure level and/or debug access permission at a non-secure level, on at least one debug command signal configuring respective access rights.

8. The method according to claim 6, further comprising: detecting on at least one debug command signal a state representing invasive debug access permission and/or non-invasive debug access permission which configures a respective degree of invasiveness.

9. The method according to claim 8, wherein detecting on the at least one debug command signal is performed in all system states except an initial “fully open” state, and further comprising providing to the processor evolving system state information.

10. The method according to claim 6, further comprising activating system protection measures in event of detection of at least one state representing debug access permission and as a function of a system access right state.
